(19) United States
(12) Patent Application Publication
(10) Pub. No.: US 2016/0290536 A1
(43) Pub. Date: Oct. 6, 2016

(54) HYDRAULIC TUBING SYSTEM

(71) Applicant: SHELL OIL COMPANY, Houston, TX (US)

(72) Inventor: Brian Kelly MCCOY, Magnolia, TX (US)

(21) Appl. No.: 15/182,004

(22) Filed: Jun. 14, 2016

Related U.S. Application Data
(60) Provisional application No. 62/241,399, filed on Oct. 14, 2015.

(51) Int. Cl. F16L 11/08

(52) U.S. Cl. CPC F16L 11/08

(57) ABSTRACT

A hydraulic tubing system wherein one or more elongate metal strips extend parallel to each other in a longitudinal direction and at least one hydraulic tubing line is disposed adjacent to the one or more elongate metal strips. The at least one hydraulic tubing line also extends along the longitudinal direction. The one or more elongate metal strips and the at least one hydraulic tubing line are together encapsulated in an encapsulation, to form an encapsulated hydraulic tubing system extending in the same longitudinal direction.

### CROSS REFERENCE TO EARLIER APPLICATION

The present application claims benefit of U.S. Provisional application No. 62/241,399 filed 14 Oct. 2015.

### FIELD OF THE INVENTION

The present invention relates to a hydraulic tubing system. Embodiments of the present invention are suitable for deployment in a borehole, for instance mounted on a tubular element.

### BACKGROUND OF THE INVENTION

A variety of subterranean operations, such as injecting of fluids into subterranean formations or recovering (producing) fluids from the subterranean formation, require drilling of a borehole. Such boreholes are typically completed with a variety of components and tools, which may include one or more of a casing, production tubing, packer, subsurface valve, gravel pack, motor, sensor. Some of these components and/or tools may require or involve a hydraulic tubing line to be run into the borehole, which can be used to transmit hydraulic power or as downhole pressure sensor. Hydraulic power may be used, for instance, for opening and closing valves or sleeves or the like, or for powering down-hole devices such as, for example, a hydraulic motor and/or a tubing conveyed perforation system.

U.S. Pat. No. 7,100,690 discloses a flat pack umbilical line that can be positioned in a wellbore between a base pipe and a screen wire. The umbilical line can be located adjacent to a portion of the base pipe. It includes an instrument line, such as a copper wire, a coaxial cable, a fiber optic bundle, a twisted pair or other line suitable for transmitting power, signals, data and the like, and a hydraulic line. In addition, the umbilical line includes a pair of bumper bars, such as braided wire, which provides added rigidity to the umbilical line.

A drawback of the umbilical line of U.S. Pat. No. 7,100,690 is that it is difficult to detect it with a magnetic flux detector from the inside of the base pipe. Such detection would allow to selectively orient a perforating tool away from the umbilical line to avoid damaging it in a perforation operation.

### SUMMARY OF THE INVENTION

In accordance with a first aspect of the present invention, there is provided a hydraulic tubing system comprising:
one or more elongate metal strips extending parallel to each other in a longitudinal direction;
at least one hydraulic tubing line disposed adjacent to the one or more elongate metal strips and extending along said longitudinal direction and parallel to each of the one or more elongate metal strips;
   wherein the one or more elongate metal strips and the at least one hydraulic tubing line are together encapsulated in an encapsulation, to form an encapsulated hydraulic tubing system extending in said longitudinal direction.

The invention will be further illustrated hereinafter by way of example only, and with reference to the non-limiting drawing.

### BRIEF DESCRIPTION OF THE DRAWING

FIG. 1 shows a perspective view of a tubular element on which a hydraulic tubing system is mounted;

FIG. 2 shows a cross sectional view of a section of the tubular element of FIG. 1 and a hydraulic tubing system according to a group of embodiments;

FIG. 3 shows a cross sectional view of a section of the tubular element of FIG. 1 and a hydraulic tubing system according to another group of embodiments;

FIG. 4 shows a front view of a hydraulic tubing system mounted on the tubular element; and

FIG. 5 shows a cross sectional view of a section of the tubular element of FIG. 1 and a hydraulic tubing system that employs non-straight metal strips.

These figures are schematic and not to scale. Identical reference numbers used in different figures refer to similar components. Within the context of the present specification, cross sections are always assumed to be perpendicular to the longitudinal direction.

### DETAILED DESCRIPTION OF THE INVENTION

The person skilled in the art will readily understand that, while the detailed description of the invention will be illustrated making reference to one or more a specific combinations of features and measures, many of those features and measures are functionally independent from other features and measures such that they can be equally or similarly applied independently in other embodiments or combinations.

The present disclosure proposes a hydraulic tubing system involving an encapsulated hydraulic tubing line. The hydraulic tubing system comprises one or more elongate metal strips and at least one hydraulic tubing line, which are together encapsulated in an encapsulation.

This hydraulic tubing system is an improvement over the system as described in U.S. Pat. No. 7,100,690. As the umbilical line of U.S. Pat. No. 7,100,690 is quite flat, the diameter of the braided wires is relatively small. Metal strips as presently proposed improve both the crush resistance and are better detectable with a magnetic flux detector. This is especially the case if the elongate metal strips are each made out of a massive volume of metal. Advantageously, of the elongate metal strips have a four-sided cross sectional contour, which also enhances the detectability and crush resistance.

The mentioned constituents are integrated into a single integrated unit, which can be relatively easily affixed to a well tubular compared to two separate metal strips and a separate hydraulic line. In preferred embodiments, the hydraulic tubing system can be spooled around a single spool drum.

Furthermore, the hydraulic tubing line in this hydraulic tubing system is well protected from the environment and against impacts from the outside. Particularly, when exposed to side loads or other forces, the metal strips may separate if not encapsulated. This would not only cause exposure of the hydraulic tubing to crushing and abrasion, it would also weaken the magnetic flux signals inside the tubular element making it harder to establish the azimuth of the hydraulic tubing system.

The material from which the encapsulation is made is suitably a thermoplastic material, and preferably an erosion-resistant thermoplastic material. Preferably, the thermoplastic material has a (relatively) high tensile modulus and yield, (relatively) high resistance against abrasion and erosion, (relatively) high melting temperature, and (relatively) high petro-chemical resistance. Suitable materials may include thermoplastic vulcanizates (TPV), of which Santoprene™ (ExxonMobil) is an example thermoplastic polyester elastomers (TPE), of which Hytrel™ TPC-ET (Dupont)is an example; thermoplastic polyurethanes (TPU) of which Lubrizol Estane™ is an example; and ECTFE, a copolymer of ethylene and chlorotrifluoroethylene of which Halar (Solvay) is an example. The latter may be employed as a coating around another encapsulation material. Ethylene propylene diene terpolymers (EPDM), which are extremely durable synthetic rubbers known to be used as roofing membranes, have also been considered.

A material that swells when exposed to steam and/or hydrocarbons may be advantageous as encapsulation material, particularly when the hydraulic tubing system is for instance embedded in a cement. Such hydraulic tubing system with encapsulation of a swellable material would have a degree of “self-sealing” property, where a cement bond around the cable is otherwise not optimal.

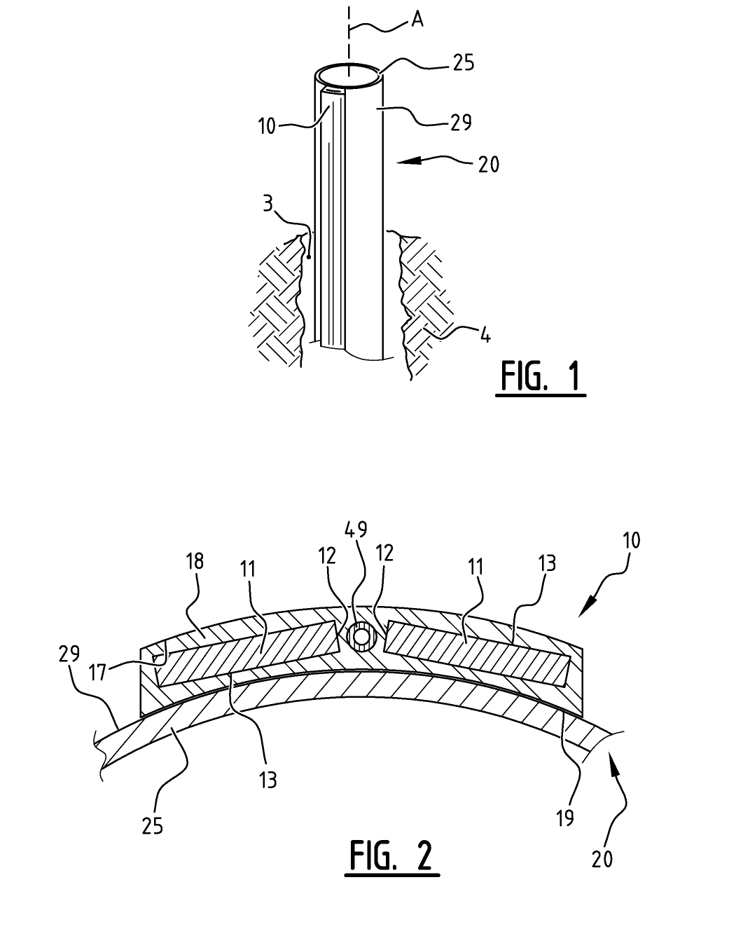

When seen in cross section, the encapsulation suitably comprises a circular concave inside contour section and a circular convex outside contour section. The one or more elongate metal strips and the at least one hydraulic tubing line may be positioned between the circular concave inside contour section and the circular convex outside contour section. Suitably, the circular concave inside contour section and the circular convex outside contour section are concentric to each other. The circular concave inside contour section further helps to stiffen the encapsulated hydraulic tubing and to keep it against a tubular element during deployment. The circular concave inside contour section advantageously has a radius of curvature that conforms to the convex outward directed wall surface of the tubular element. This further improves both the mechanical protection when running the tubular element in a borehole as well as the detectability of magnetic flux signals inside the tubular element. Referring now to FIG. 1, there is shown a perspective view of a hydraulic tubing system 10 mounted on a tubular element 20. The tubular element comprises a cylindrical wall 25 extending about a central axis A, which is parallel to a longitudinal direction. The cylindrical wall 25, seen in cross section, has a circular circumference having a convex outward directed wall surface 29. The hydraulic tubing system 10 is a fully encapsulated hydraulic tubing system that extends in the longitudinal direction.

The tubular element 20 may be deployed inside a borehole 3 drilled in an earth formation 5. The tubular element 20 may be (part of) any kind of well tubular, including for example but not limited to: casing, production tubing, lining, cladding, coiled tubing, or the like. The tubular element 20 may be any tubular or other structure that is intended to remain in the borehole 3 at during the duration of use of the hydraulic line. The tubular element 20, together with the hydraulic tubing system 10, may be cemented in place.

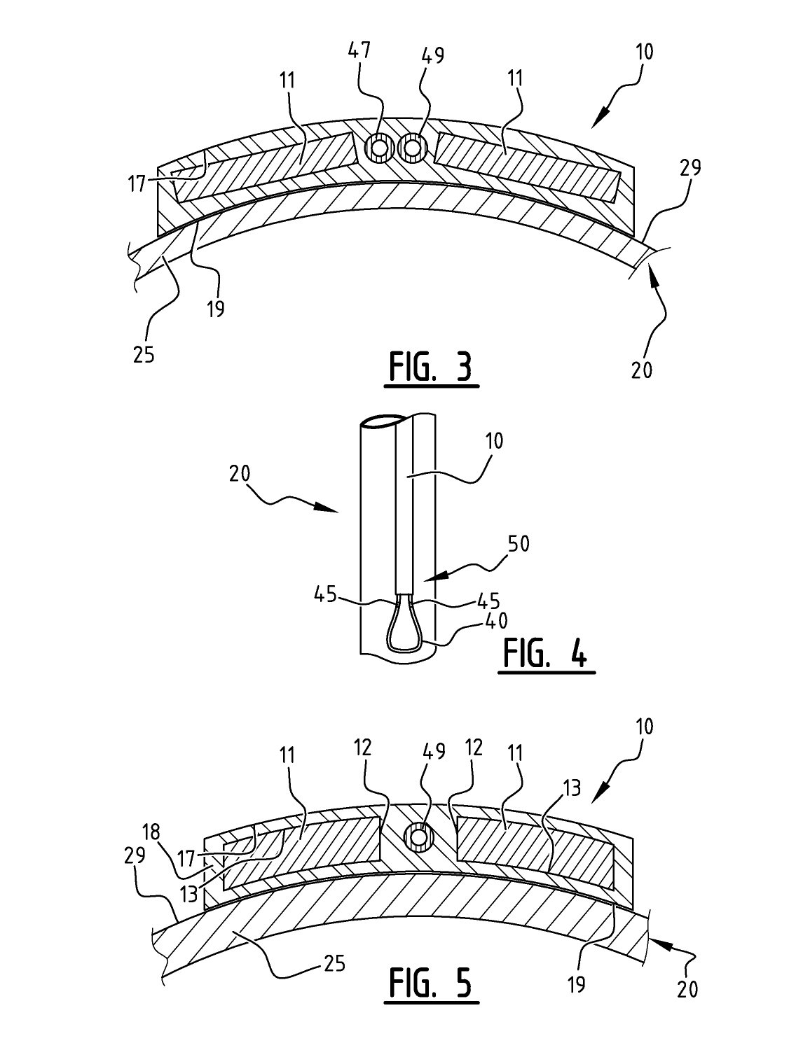

Two examples of the hydraulic tubing system 10 are illustrated in FIGS. 2 and 3. These figures provide cross sectional views on a plane that is perpendicular to the longitudinal direction.

Starting with FIG. 2, the hydraulic tubing system 10 comprises (at least) two elongate metal strips 11 and (at least) one hydraulic tube 49 disposed between the elongate metal strips 11. The hydraulic tube 49 and the elongate metal strips 11 all extend parallel to each other in the longitudinal direction (perpendicular to the plane of view). The elongate metal strips 11 and the hydraulic tubing line are together encapsulated in an encapsulation 18, thereby forming an encapsulated hydraulic tubing system extending in the longitudinal direction. In the embodiment of FIG. 2, the hydraulic tube and the elongate metal strips 11 are fully surrounded by the encapsulation 18.

Suitably, the at least one hydraulic tubing line may be a hydraulic capillary line, suitably formed out of a hydraulic capillary tube. Such hydraulic capillary tubes are sufficiently pressure resistant to contain a hydraulic fluid. Such hydraulic capillary tubes are known to be used as hydraulic control lines for a variety of purposes when deployed on a well tubular in a borehole. They can, for instance, be used to transmit hydraulic power to open and/or close valves or sleeves or to operate specific down-hole devices. They may also be employed to monitor downhole pressures, in which case they may be referred to as capillary pressure sensor. Such hydraulic capillary tube may also be suited in case data communication lines or distributed sensors are pumped through the hydraulic tubing.

FIG. 3 shows an alternative group of embodiments, wherein the at least one hydraulic tubing line comprises a first length of hydraulic tubing 47 that is provided within the encapsulation. The first length of hydraulic tubing 47 extends along the longitudinal direction.

Preferred embodiments comprise a second length of hydraulic tubing 49 within the encapsulation, in addition to the first length of hydraulic tubing 47. The material from which the second length of hydraulic tubing 49 is made, and/or the specifications for the second length of hydraulic tubing 49, may be identical to that of the first length of hydraulic tubing 47. The second length of hydraulic tubing 49 suitably extends parallel to the first length of hydraulic tubing 47.

Suitably, as schematically illustrated in FIG. 4, the hydraulic tubing system 10 having first and second lengths of hydraulic tubing may further comprise a hydraulic tubing U-turn piece 40. The hydraulic tubing U-turn piece 40 is suitably configured at a distal end 50 of the encapsulated hydraulic tubing 10, and it may function to create a pressure containing fluid connection between the first length of hydraulic tubing 47 and the second length of hydraulic tubing 49. When the hydraulic tubing system 10 is inserted into a borehole, as schematically depicted in FIG. 1, the distal end 50 of the hydraulic tubing system 10 suitably is the end that is inside the borehole 3 and furthest away from the surface of the earth in which the borehole 3 has been drilled. Suitably, connectors 45 are configured between the first length of hydraulic tubing 47 and the second length of hydraulic tubing 49 and respective ends of the hydraulic tubing U-turn piece 40. One way in which the hydraulic tubing U-turn piece 40 can be used is provide a continuous hydraulic circuit having a pressure fluid inlet and return line outlet at a single end of the hydraulic tubing system 10. This single end may be referred to as proximal end. The preferred embodiments facilitate pumping a hydraulic fluid down hole from the surface of the earth and circulating it back to the surface, even if the well has already been completed and perforated.

More than two lengths of hydraulic tubing within a single encapsulation has also been contemplated.

The following part of the disclosure concerns subject matter that may apply to both the group of embodiments that is represented by FIG. 2, and the other group of embodiments that is represented by FIG. 3. Reference numbers have been employed in both figures.

The material from which the encapsulation 18 is made is suitably a thermoplastic material. Preferably the material is an erosion-resistant thermoplastic material.

Seen in said cross section, the encapsulation 18 preferably comprises a circular concave inside contour 19 section and a circular convex outside contour section 17, wherein the one or more elongate metal strips 11 and the at least one hydraulic tube are positioned between the circular concave inside contour section 19 and the circular convex outside contour section 17. When mounted on the tubular element 20, the circular concave inside contour section 19 suitably has a radius of curvature that conforms to the convex outward directed wall surface 29 of the tubular element 20.

The elongate metal strips 11 are each made out of a massive volume of metal, and each have a rectangular cross section. Other four-sided shapes have been contemplated as well, including parallelograms and trapeziums. Suitably the four-sided cross sections comprise two short sides 12 and two long sides 13, whereby the metal strips are configured within the encapsulation with one short side 12 of one of the metal strips facing toward one short side 12 of the other of the metal strips, whereby the hydraulic tube is between these respective short sides.

The metal is suitably steel, but any electrically conductive or ferromagnetic material such as nickel, iron, cobalt, and alloys thereof, may provide satisfactory mechanical protection of the hydraulic tubing line and magnetic flux signals inside the tubular element. The metal strips may for instance be extruded or roll formed. Suitably, for borehole applications the short sides measure less than 6.5 mm, preferably less than 4 mm, but more than 2 mm Thicknesses less than 2 mm provide insufficient magnetic flux signals inside the tubular element to detect, while thickness exceeding 6.5 mm is considered unfavourable to manage during the installation. The long sides are preferably more than 4× longer than the short sides. Suitably, the long sides are not more than 7× longer than the short sides, this in the interest of the encapsulation. The outer diameter of the hydraulic tubing may be between 2 mm and 6.5 mm, or preferably between 2 mm and 4 mm.

Sides of the four-sided shape can be, but are not necessarily, straight. For instance, one or more of the sides may be curved. For instance, it is contemplated that one or both of the long sides are shaped according to circular contours. An example is illustrated in FIG. 5. The circular contours may be mutually concentric, and, if the hydraulic tubing system is mounted on a tubular element, the circular contours may be concentric with the contour of the outward directed wall surface 29. If the encapsulation 18 comprises a circular concave inside contour 19 section and/or a circular convex outside contour section 17, circular contours of the elongate metal strips may be concentric with the circular concave inside contour 19 section and/or the circular convex outside contour section 17. Embodiments that employ metal strips 11 with non-straight sides may in all other aspects be identical to other embodiments described herein.

The hydraulic tubing system comprising the encapsulated hydraulic tubing line is suitably spoolable around a spool drum. This facilitates deployment at a well site, for instance. The metal strips 11 can be taken advantage of when perforating the tubular element 20 on which the hydraulic tubing system is mounted, as the azimuth of the hydraulic tubing system may be established from inside of the tubular element by detecting magnetic flux signals inside the tubular element. Perforating guns and magnetic orienting devices are commercially available in the market.

The person skilled in the art will understand that the present invention can be carried out in many various ways without departing from the scope of the appended claims. For instance, while FIGS. 2, 3, and 5 each show two elongate metal strips, it is possible to omit one of the two metal strips, or to employ additional metal strips.

What is claimed is:

1. A hydraulic tubing system comprising:
one or more elongate metal strips extending parallel to each other in a longitudinal direction;
at least one hydraulic tubing line disposed adjacent to the one or more elongate metal strips and extending along said longitudinal direction and parallel to each of the one or more elongate metal strips;
wherein the one or more elongate metal strips and the at least one hydraulic tubing line are together encapsulated in an encapsulation, to form an encapsulated hydraulic tubing system extending in said longitudinal direction.

2. The hydraulic tubing system of claim 1, wherein seen in a cross section perpendicular to the longitudinal direction the one or more elongate metal strips and the at least one hydraulic tubing line are fully surrounded by the encapsulation.

3. The hydraulic tubing system of claim 2, wherein seen in said cross section the encapsulation comprises a circular concave inside contour section and a circular convex outside contour section wherein the one or more elongate metal strips and the at least one hydraulic tubing are positioned between the circular concave inside contour section and the circular convex outside contour section.

4. The hydraulic tubing system of claim 3, mounted on a tubular element, the tubular element comprising a cylindrical wall about a central axis that is parallel to the longitudinal direction, wherein the cylindrical wall seen in cross section has a circular circumference having a convex outward directed wall surface; wherein the circular concave inside contour section has a radius of curvature that conforms to the convex outward directed wall surface.

5. The hydraulic tubing system of claim 1, wherein the one or more elongate metal strips are each made out of a massive volume of metal and each have a four-sided cross section.

6. The hydraulic tubing system of claim 1, wherein the at least one hydraulic tubing line is a capillary line.

7. The hydraulic tubing system of claim 1, wherein the at least one hydraulic tubing line comprises a first length of hydraulic tubing that is provided within the encapsulation and extends in the longitudinal direction.

8. The hydraulic tubing system of claim 7, further comprising a second length of hydraulic tubing within the encapsulation, extending parallel to the first length of hydraulic tubing.

9. The hydraulic tubing system of claim 8, further comprising a hydraulic tubing U-turn piece, configured at a distal end of the encapsulated hydraulic tubing to create a pressure containing fluid connection between the first length of hydraulic tubing and the second length of hydraulic tubing.

10. The hydraulic tubing system of claim 1, wherein the encapsulation is made of a thermoplastic material.

11. The hydraulic tubing system of claim 1, wherein said one or more elongate metal strips comprise at least two elongate metal strips extending parallel to each other.

12. The hydraulic tubing system of claim 11, wherein the at least one hydraulic tubing line is disposed between at least two of the one or more elongate metal strips.

13. The hydraulic tubing system of claim 1, wherein the encapsulated hydraulic tubing system is spoolable around a spool drum.
